(19) United States
(12) Patent Application Publication
(10) Pub. No.: US 2011/0166316 A1
(43) Pub. Date: Jul. 7, 2011

(54) POLYURETHANES BASED ON POLYESTER DIOLS WITH IMPROVED CRYSTALLIZATION BEHAVIOR

(75) Inventors: Joern Duwenhorst, Lemfoerde (DE); Frank Prissok, Lemfoerde (DE); Lionel Gehringer, Schaffhouse-pres-Seltz (FR)

(73) Assignee: BASF SE, Ludwigshafen (DE)

(21) Appl. No.: 13/063,854

(22) PCT Filed: Sep. 16, 2009
(86) PCT No.: PCT/EP2009/062019

§ 371 Date: Mar. 14, 2011

(30) Foreign Application Priority Data
Sep. 18, 2008 (EP) 08164554.1

(51) Int. Cl. C08G 18/00

(52) U.S. Cl. 528/74.5; 528/80

(57) ABSTRACT

Polyurethanes are based on a polyester diol formed from a dicarboxylic acid having an even number of carbon atoms and a diol having an odd number of carbon atoms.

This invention relates to novel polyurethanes, more particularly thermoplastic polyurethanes, and to their use. Polyurethanes and also thermoplastic polyurethanes are already long known and have come to be widely used. For instance, polyurethanes are used in the footwear and automotive industries, for self-supporting films/sheets, cable sheathing or in leisure articles, and also variously as a blend component.

Commercially, there is increasing demand for polyurethane products where all or some of the petrochemical raw materials are replaced by raw materials from renewable sources. Sebacic acid is a renewable raw material obtained from vegetable oil (castor oil) for example. However, sebacic esters tend to crystallize, which is undesirable for many applications and so rules them out of many applications. U.S. Pat. No. 5,695,884 discloses the use of polyester polyols based on sebacic acid for thermoplastic polyurethanes of high crystallinity. US 2006/0141883 A1 and US 2006/0121812 also describe the use of polyester polyols based on sebacic acid for polyurethanes for fibers having a high melting point. WO 00/51660 A1 describes polyurethanes for heart catheters which can utilize polyester polyols based on sebacic acid; again, sufficient hardness is required. US 2007/0161731 A1 and U.S. Pat. No. 6,395,833 B1 further disclose using sebacic acid to produce polyester polyols for use in polyurethane chemistry.

It is an object of the present invention to provide polyester diols that are distinctly less prone to crystallize. More particularly, they should be useful for preparing transparent thermoplastic polyurethanes.

We have found that this object is achieved by polyurethanes based on
i) at least one isocyanate A,
ii) at least one polyester diol B, and
iii) optionally chain extenders C and further assistants,
wherein said polyester diol B is based on a dicarboxylic acid having an even number of carbon atoms and a diol having an odd number of carbon atoms.

To determine the number of carbon atoms, count only the carbon atoms directly between the carboxyl groups of the dicarboxylic acid and only the carbon atoms directly between the OH groups of the diols and not the carbon atoms in branches.

In a preferred embodiment, the dicarboxylic acid conforms to the following formula:

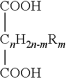

where
n is an even number, more particularly 2, 4, 6, 8, 10, 12, 14, 16,
m is 0 or an integer from 1 to 2n, preferably 0, 1 or 2, and
R is alkyl of 1 to 18 carbon atoms,
and the diol conforms to the following formula:

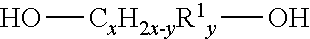

where
x is an odd number, more particularly 1, 3, 5, 7, 9, 11,
y is 0 or an integer from 1 to 2×, preferably 0, 1 or 2, and
R¹ is alkyl of 1 to 18 carbon atoms.

The polyurethanes of the present invention surprisingly display reduced crystallization and improved transparency, while branched diols also contribute to a distinct suppression of so-called soft phase crystallization. Unbranched diols are particularly preferred. In another preferred embodiment, branched diols are used as a portion together with unbranched diols, although generally more than 50 mol % of unbranched diols are used, based on the totality of diols.

In a further preferred embodiment, the polyurethane of the present invention comprises a thermoplastic polyurethane.

In a further preferred embodiment, the polyurethanes obtained are transparent.

In a further preferred embodiment, the glass transition temperature of the polyurethane of the present invention, determined via dynamic mechanical analysis (DMA), is smaller than that of a comparably obtained polyurethane having whichever is the next higher even diol and/or dd dicarboxylic acid in said polyester diol B.

In one preferred embodiment, the molecular weight of the polyester diol is between 500 to 4000 g/mol, more preferably between 800 and 2500 g/mol and even more preferably between 1000 and 2000 g/mol (corresponding to an OH number of 28 to 224 and preferably 112 to 56 mg KOH/g). In a further preferred embodiment, the dicarboxylic acid underlying the polyester diol B is sebacic acid. In a further preferred embodiment, the diol is 1,3-propanediol. In a particularly preferred embodiment, the polyester diol B is a propanediol sebacate.

Processes for preparing polyester diols by polycondensation of the corresponding diols with at least one dicarboxylic acid preferably at elevated temperature and reduced pressure preferably in the presence of known catalysts are common knowledge and have been extensively described.

Processes for preparing polyurethanes are likewise common knowledge. For example, thermoplastic polyurethanes are obtainable by reaction of (a) isocyanates with (b) isocyanate-reactive compounds having a molecular weight of 500 to 10 000 g/mol and optionally (c) chain-extending agents having a molecular weight of 50 to 499 g/mol optionally in the presence of (d) catalysts and/or (e) customary assistants.

According to the present invention, the preferred thermoplastic polyurethanes are prepared by reaction of isocyanate A with polyester diol B and optionally further isocyanate-reactive compounds and optionally chain-extending agents C optionally in the presence of catalysts D and/or customary assistants E, wherein sebacic acid propanediol is used with particular preference.

The polyurethane of the present invention can also be obtained via the intermediate stage of prepolymers. Only incomplete chains of the polymer are initially prepared in order that the end-user may have the benefit of simpler processing, particularly of the isocyanate component. The incompletely reacted starting materials thus provided are also referred to as the system, which are very important in the manufacture of shoe soles for example.

The components A, B, C and also optionally D and/or E customarily used in the manufacture of polyurethanes will now be described by way of example:
a) As organic isocyanates A they may be used commonly known aromatic, aliphatic, cycloaliphatic and/or araliphatic isocyanates, preferably diisocyanates, for example 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate, tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1-isocyanato-4-[(4-isocyanatocyclohexyl)methyl]cyclohexane (H12MDI), 2,6-diisocyanatohexanecarboxylic ester, 1,4- and/or 1,3-bis(isocyanatomethyl)-cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, preferably 2,2′-, 2,4′- and/or 4,4′-diphenylmethane diisocyanate (MDI), 1,5-naphthylene diisocyanate (NDI), 2,4- and/or 2,6-tolylene diisocyanate (TDI), hexamethylene diisocyanate, 1-isocyanato-4-[(4-isocyanatocyclohexyl)-methyl]cyclohexane, and/or IPDI, more particularly 4,4′-MDI and/or hexamethylene diisocyanate and/or H12MDI.
b) The polyester diols B described at the beginning are used as isocyanate-reactive compounds. Optionally, further commonly known isocyanate-reactive compounds can be used in addition, examples being polyester diols, polyetherols and/or polycarbonate diols, each are customarily subsumed as well under the term “polyols”, having molecular weights of 500 to 12 000 g/mol, preferably 600 to 6000 g/mol, and especially 800 to 4000 g/mol, and preferably an average functionality of 1.8 to 2.3, preferably 1.9 to 2.2, more particularly 2. Preferably, the polyester diols B of the present invention are the only polyols used.
c) Useful chain-extending agents C include commonly known aliphatic, araliphatic, aromatic and/or cycloaliphatic compounds having a molecular weight of 50 to 499 g/mol, preferably 2-functional compounds, examples being alkanediols having 2 to 10 carbon atoms in the alkylene radical, preferably 1,4-butanediol, 1,6-hexanediol and/or di-, tri-, tetra-, penta-, hexa-, hepta-, octa-, nona- and/or decaalkylene glycols of 3 to 8 carbon atoms, preferably unbranched alkanediols, more particularly 1,3-propanediol and 1,4-butanediol.
d) Suitable catalysts D for speeding in particular reaction between NCO groups of the diisocyanates A and component B are the customary tertiary amines known in the prior art, for example triethylamine, dimethylcyclohexylamine, N-methylmorpholine, N,N′-dimethylpiperazine, 2-(dimethylaminoethoxy)ethanol, diazabicyclo-(2,2,2)octane and the like and also, more particularly, organic metal compounds such as titanium esters, iron compounds such as, for example, iron(III) acetylacetonate, tin compounds, for example tin diacetate, tin dioctoate, tin dilaurate or the tin dialkyl salts of aliphatic carboxylic acids such as dibutyltin diacetate, dibutyltin dilaurate or the like. The catalysts are customarily used in amounts of 0.00001 to 0.1 parts by weight per 100 parts by weight of polyhydroxy compound (b).
e) In addition to catalysts D, may also have the structural components A to C added to them customary auxiliaries E. Examples are blowing agents, surface-protective substances, flame retardants, nucleating agents, lubricating and demolding aids, dyes and pigments, stabilizers, for example against hydrolysis, light, heat or discoloration, inorganic and/or organic fillers, reinforcing agents, plasticizers and metal deactivators. Hydrolysis control agents used are preferably oligomeric and/or polymeric aliphatic or aromatic carbodiimides. To stabilize the polyurethane of the present invention against aging, the polyurethane preferably has stabilizers added to it. Stabilizers for the purposes of the present invention are additives which protect a plastic or a plastic mixture against harmful environmental effects. Examples are primary and secondary antioxidants, thiosynergists, organophosphorus compounds of trivalent phosphorus, hindered amine light stabilizers, UV absorbers, hydrolysis control agents, quenchers and flame retardants. Examples of commercial stabilizers are given in Plastics Additive Handbook, 5th Edition, H. Zweifel, ed., Hanser Publishers, Munich, 2001 ([1]), p. 98-p. 136. When the polyurethane of the present invention is exposed to thermal oxidative damage, during use, antioxidants can be added. Preference is given to using phenolic antioxidants. Examples of phenolic antioxidants are given in Plastics Additive Handbook, 5th edition, H. Zweifel, ed, Hanser Publishers, Munich, 2001, pp. 98-107 and p. 116-p. 121. Preference is given to phenolic antioxidants having a molecular weight greater than 700 g/mol. One example of a phenolic antioxidant which is preferably used is pentaerythrityl tetrakis (3-(3,5-bis(1,1-dimethylethyl)-4-hydroxyphenyl)propionate) (Irganox® 1010) or other high molecular weight condensation products formed from corresponding antioxidants. The phenolic antioxidants are generally used in concentrations of between 0.1% and 5% by weight, preferably between 0.1% and 2% by weight and especially between 0.5% and 1.5% by weight, all based on the total weight of the polyurethane. Preference is further given to using antioxidants which are amorphous or liquid. Even though the polyurethanes of the present invention are by virtue of their preferable composition distinctly more stable to ultraviolet radiation than, for example, polyurethanes plasticized with phthalates or benzoates, stabilization with phenolic stabilizers only is often insufficient. For this reason, the polyurethanes of the present invention which are exposed to UV light are preferably additionally stabilized with a UV absorber. UV absorbers are molecules which absorb high energy UV light and dissipate the energy. UV absorbers widely used in industry belong for example to the group of the cinnamic esters, the diphenyl cyanoacrylates, the oxamides (oxanilides), more particularly 2-ethoxy-2′-ethyloxanilide, the formamidines, the benzylidenemalonates, the diarylbutadienes, triazines and also the benzotriazoles. Examples of commercial UV absorbers are given in Plastics Additive Handbook, 5th edition, H. Zweifel, ed, Hanser Publishers, Munich, 2001, pp. 116-122. In a preferred embodiment, the UV absorbers have a number average molecular weight greater than 300 g/mol and more particularly greater than 390 g/mol. Furthermore, the UV absorbers which are preferably used should have a molecular weight of not greater than 5000 g/mol and more preferably of not greater than 2000 g/mol. The group of the benzotriazoles is particularly useful as UV absorbers. Examples of particularly useful benzotriazoles are Tinuvin® 213, Tinuvin® 328, Tinuvin® 571, and also Tinuvin® 384 and Eversorb®82. The UV absorbers are preferably added in amounts between 0.01% and 5% by weight, based on the total mass of polyurethane, more preferably between 0.1% and 2.0% by weight and especially between 0.2% and 0.5% by weight, all based on the total weight of the polyurethane. Often, an above-described UV stabilization based on an antioxidant and a UV absorber is still not sufficient to ensure good stability for the polyurethane of the present invention against the harmful influence of UV rays. In this case, a hindered amine light stabilizer (HALS) can preferably be added to component E in addition to the antioxidant and the UV absorber. A particularly preferred UV stabilization comprises a mixture of a phenolic stabilizer, a benzotriazole and a HALS compound in the above-described preferred amounts. However, it is also possible to use compounds which combine the functional groups of the stabilizers, for example sterically hindered piperidylhydroxybenzyl condensation products such as for example di(1,2,2,6,6-pentamethyl-4-piperidyl) 2-butyl-2-(3,5-di-tert-butyl-4-hydroxybenzyl) malonate, Tinuvin® 144.
Particular suitability also extends to waxes which perform important functions not only in the industrial production of the polyurethanes but also in their processing. The wax serves as a friction-reducing internal and external lubricant and thus improves the flow properties of the polyurethane. In addition, it is said to act as a release agent preventing the adherence of polyurethane to the surrounding material (the mold for example), and as a dispersant for other added substances, for example pigments and antiblocking agents. Suitable are for example fatty acid esters, such as stearic esters and montan esters and their metal soaps, but also fatty acid amides, such as stearylamides and oleamides, or else polyethylene waxes. An overview of waxes used in thermoplastics is given in H. Zweifel (Ed.): Plastics Additives Handbook, 5th edition, Hanser Verlag, Munich 2001, pp. 443 ff., EP-A 308 683, EP-A 670 339 and JP-A 5 163 431.
Improvements can also be achieved through the use of ester and amide combinations as per DE-A 19 607 870 and through the use of specific wax mixtures of montan acid and fatty acid derivatives (DE-A 19 649 290), and also through the use of hydroxystearylamides as per DE 102006009096 A1.
A particularly preferred embodiment utilizes fatty acids as per DE-A-19706452 of 24 to 34 carbon atoms and/or esters and/or amides of these fatty acids in the case of polyurethanes with desired reduced tendency to take up and/or give off substances, for which the fatty acids and/or their derivatives are used in a weight fraction of 0.001% to 15% by weight, based on the total weight of the polyisocyanate polyaddition products.
A further preferred embodiment utilizes a mixture as per EP-A-1826225 of the reaction products of alkylenediamines with a) one or more linear fatty acids and of alkylenediamines with b) 12-hydroxystearic acid and/or of the reaction products of alkylenediamines with c) 12-hydroxystearic acid and one or more linear fatty acids. This mixture thus comprises the reaction products of alkylenediamine with a) and b) and/or c).

Further details about the abovementioned auxiliary and added substances are discernible from the technical literature, for example from Plastics Additive Handbook, 5th edition, H. Zweifel, ed, Hanser Publishers, Munich, 2001. All molecular weights mentioned in this reference have the unit [g/mol].

In a further preferred embodiment, the dicarboxylic acid and/or the diol of said polyester diol B and/or said chain extender C are of nonfossil origin.

The preparation of the polyurethanes can be carried out according to the known processes as a batch operation or as a continuous operation, for example using reactive extruders or the belt process by the one shot or the prepolymers process, preferably by the one shot process. In these processes, the reactant components A, B and optionally C, D and/or E can be mixed in succession or at the same time, and the reaction ensues immediately. In the extruder process, the structural components A, B and also optionally C, D and/or E are introduced into the extruder individually or as a mixture, reacted at temperatures of 100 to 280° C. and preferably 140 to 250° C., for example, and the polyurethane obtained is extruded, cooled down and pelletized.

The processing of the polyurethanes of the present invention, which are typically in the form of pellets or powders, to form the desired self-supporting films/sheets, molded parts, rollers, fibers, linings in automobiles, hoses, cable plugs, bellows, drag cables, cable sheathing, gaskets, belts or shock-absorbing elements is effected according to customary processes, for example injection molding, calendering or extrusion. The thermoplastic polyurethanes obtainable by the processes of the present invention, preferably coatings, cables, floors for buildings and transportations, plug connectors, solar modules, self-supporting films/sheets, molded parts, shoe soles and shoe parts, rollers, fibers, linings in automobiles, profiles, laminates and wiper blades, hoses, cable plugs, bellows, drag cables, cable sheathing, gaskets, nonwoven fabrics, belts or shock-absorbing elements have the advantages described at the beginning.

### EXAMPLES

### Example 1

The dicarboxylic acids and diols apparent from Table 1 were reacted in vacuum in a dicarboxylic acid/diol ratio of about 1/1. Next this polyester diol was admixed with butanediol chain extender while stirring. Following subsequent heating of the solution to 80° C., methylenediphenyl diisocyanate (MDI) was added and stirred in until the solution was homogeneous.

The crystallization temperatures of the polyurethane obtained were determined as follows:

The glass transition temperature Tg of the soft phase was determined by dynamic mechanical analysis (DMA). Here the maximum of tan 8 corresponds to the glass transition temperature Tg. The DMA measurement was carried out on an instrument from Rheometric Scientific (ARES). The measurements were carried out as per DIN EN ISO 6721.

The values apparent from Table 1 below were obtained:

TABLE 1
Influence of diol chain length

| | | | Molecular | Tg |
|---|---|---|---|---|
| No. | Acid | Diol | weight [g/mol] | (° C.) |
| 1 | sebacic acid | ethanediol | 1000 | 9.2 |
| 2 | sebacic acid | propanediol | 1000 | −6.0 |
| 3 | sebacic acid | butanediol | 1000 | 9.9 |
| 4 | sebacic acid | pentanediol | 1000 | 9.5 |
| 5 | sebacic acid | hexanediol | 1000 | 14.5 |

TABLE 2
Molecular weight polyol 1000, TPU hardness
Shore 95A (butanediol versus propanediol)

| | | | Molecular | Tg |
|---|---|---|---|---|
| No. | Acid | Diol | weight [g/mol] | (° C.) |
| 6 | suberic acid | propanediol | 1000 | 3.7 |
| 7 | suberic acid | butanediol | 1000 | 4.1 |
| 2 | sebacic acid | propanediol | 1000 | −6.0 |
| 3 | sebacic acid | butanediol | 1000 | 9.9 |
| 8 | dodecanedioic | propanediol | 1000 | 8.1 |
| | acid | | | |
| 9 | dodecanedioic | butanediol | 1000 | 14.4 |
| | acid | | | |

TABLE 3
Molecular weight 2000, TPU hardness
Shore 95A (butanediol versus propanediol)

| | | | Molecular | Tg |
|---|---|---|---|---|
| No. | Acid | Diol | weight [g/mol] | (° C.) |
| 10 | sebacic acid | propanediol | 2000 | −26.6 |
| 11 | sebacic acid | butanediol | 2000 | −6.1 |

Implications are as follows:
Comparing examples 1-5 in Table 1 it is clear that the glass transition temperature increases with increasing diol length. This effect is generally described as soft phase crystallization. Surprisingly, inventive example 2 shows a distinctly lower propensity for soft phase crystallization. As soft phase crystallization increases, the material becomes more opaque and displays worse low temperature impact toughness.
Comparing each of examples 2, 6 and 8 (propanediol in polyester diol B) with examples 3, 7 and 9 (butanediol in polyester diol B), it is clearly apparent that the inventive polyester diols with propanediol are under otherwise similar conditions superior to polyester diols based on butanediol in respect of crystallization, so that test plates with higher molecular weights of the polyester diol B are transparent, while those from butanediol are opaque.
As the polyol molecular weight increases, a person skilled in the art would also expect this effect to increase. To this end, examples 10 and 11 in Table 3 were prepared in addition to Table 1. Surprisingly, the soft phase crystallization propensity of inventive example 12 is even less pronounced than that of example 2. The lower soft phase crystallization also manifests itself in the transparency of the test plates from example 10, while the test plates from 11 are opaque.

1. A polyurethane, comprising:
at least one isocyanate A,
at least one polyester diol B, and
optionally at least one chain extender C and at least one further assistant,
wherein said polyester diol B comprises a dicarboxylic acid having an even number of carbon atoms and a diol having an odd number of carbon atoms.

2. The polyurethane according to claim 1 wherein the dicarboxylic acid conforms to formula (I) 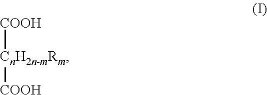
wherein
n is an even number,
m is 0 or an integer from 1 to 2n, an
R is alkyl of 1 to 18 carbon atoms,
and the diol conforms to formula (II) 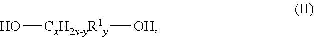
wherein
x is an odd number,
y is 0 or an integer from 1 to 2×, and
R¹ is alkyl of 1 to 18 carbon atoms.

3. The polyurethane according to claim 1, wherein the Polyurethane is a thermoplastic polyurethane (TPU).

4. The polyurethane according to claim 1, wherein said isocyanate A is selected from the group consisting of
2,2′-diphenylmethane diisocyanate,
2,4′-diphenylmethane diisocyanate,
4,4′-diphenylmethane diisocyanate (MDI),
2,4-tolylene diisocyanate,
2,6-tolylene diisocyanate (TDI),
hexamethylene diisocyanate, and
1-isocyanato-4-[(4-isocyanato cyclohexyl)methyl]cyclohexane (H12MDI).

5. The polyurethane according to claim 1, wherein the dicarboxylic acid is sebacic acid.

6. The polyurethane according to claim 1, wherein the diol is 1,3-propanediol.

7. The polyurethane according to claim 1, wherein said polyester diol B is a propanediol sebacate.

8. The polyurethane according to claim 1, wherein the molecular weight of said polyester diol B is between 500 and 4000 g/mol.

9. The polyurethane according to claim 1, wherein said polyester diol B is a propanediol sebacate having an OH number of 28 to 224.

10. The polyurethane according to claim 1, wherein at least one of the dicarboxylic acid, the diol, of said and said chain extender C is of nonfossil origin.

11. The polyurethane according to claim 1, wherein the polyurethane is transparent.

12. The polyurethane according to claim 3, wherein a glass transition temperature of the TPU measured as tan δ, is smaller than that of a comparably obtained TPU having a next higher even diol or a next higher odd dicarboxylic acids in said polyester diol B.

13. The polyurethane according to claim 1, comprising
at least one selected from the group consisting of a fatty acid of 24 to 34 carbon atoms, an ester of the fatty acid, and an amide of the fatty acid, or
a mixture of at least one reaction product of at least one alkylenediamine with at least one selected from the group consisting of
a) at least one linear fatty acid,
b) at least one of 12-hydroxystearic acid, and
c) 12-hydroxystearic acid and at least one linear fatty acid.

14. A molded article, extruded article, or non-woven article, comprising:
the polyurethane according to claim 1.

15. The polyurethane according to claim 2, wherein n is 2, 4, 6, 8, 10, 12, 14, or 16.

16. The polyurethane according to claim 2, wherein m is 0, 1, or 2.

17. The polyurethane according to claim 2, wherein x is 1, 3, 5, 7, 9, or 11.

18. The polyurethane according to claim 2, wherein y is 0, 1, or 2.

19. The polyurethane according to claim 1, wherein said polyester diol B is a propanediol sebacate having an OH number of 56 to 112.
